(19) United States
(12) Patent Application Publication
(10) Pub. No.: US 2018/0096806 A1
(43) Pub. Date: Apr. 5, 2018

(54) LIGHT-EMITTING KEYBOARD

(71) Applicant: ALSON TECHNOLOGY LIMITED, HONG KONG (HK)

(72) Inventors: Han-Hung CHENG, Zhubei City (TW); Chi-Fen KUO, Zhubei City (TW)

(21) Appl. No.: 15/284,889

(22) Filed: Oct. 4, 2016

(51) Int. Cl. H01H 13/83; F21V 23/02; F21V 23/06

(52) U.S. Cl. CPC H01H 13/83; H01H 2219/036; F21V 23/06; F21V 23/02

(57) ABSTRACT

A light-emitting keyboard is provided, including a keyboard module and a light-emitting module. The keyboard module has a cover, a base, a circuit substrate, a first electric transmission portion and a plurality of keycaps. The light-emitting module includes a shell, a substrate, a boost circuit and a plasma tube, the boost circuit includes a power input portion, the power input portion forms a second electric transmission portion, and the second electric transmission portion is separatably electrically connected to the first electric transmission portion.

### BACKGROUND OF THE INVENTION

### Field of the Invention

The present invention relates to a light-emitting keyboard.

### Description of the Prior Art

A conventional keyboard is simply an input device, and as computer becomes widely popular, the conventional keyboard is gradually unable to meet consumers' requirements. Therefore, a keyboard having a light source is provided so that a user can recognize the characters or functions of keycaps in an environment where light is weak. This type of light-emitting keyboard is disclosed in TWI508119.

However, this type of light-emitting keyboard often uses a light-emitting diode, it is understandable that the light-emitting diode is a light-emitting component which has higher illuminating efficiency, and when light emitted by the light-emitting diode enters a user's eyes, s/he may feel uncomfortable. Therefore, most of the keyboards are provided with a backlight module, but in this way, the user cannot see a surface of the keycap clearly, or the keyboard or the keycap need to use a more complex structure to guide the light and soften the light, and this type of keyboard is more complex and costly to be processed.

The present invention has arisen to mitigate and/or obviate the afore-described disadvantages.

### SUMMARY OF THE INVENTION

The major object of the present invention is to provide a light-emitting keyboard, which can light up keycaps so that a user can see the keycaps clearly, and his/her eyes do not feel uncomfortable. A light-emitting module is engaged with a keyboard module externally, and the light-emitting module and keyboard module may be engaged/disengaged with each other. In addition, during a manufacturing process, the keyboard does not need to undergo light-guiding or light-softening processes so that a manufacturing difficulty is lowered, and a complexity of the keyboard structure is decreased.

To achieve the above and other objects, al light-emitting keyboard is provided, including a keyboard module and a light-emitting module. The keyboard module has a cover, a base, a circuit substrate, a first electric transmission portion and a plurality of keycaps, the cover covers the base, the cover and the base define an interior space, the circuit substrate is for being electrically connected to a first power source and disposed in the interior space, the first electric transmission portion is for being electrically connected to a second power source, each said keycap is reciprocatably positioned on the cover, and the keycaps are for being optionally pressed to actuate a part of the circuit substrate. The light-emitting module includes a shell, a substrate, a boost circuit and a plasma tube, the shell has a light-penetrable portion, the boost circuit is disposed on the substrate, the boost circuit includes at least one conductive line and a plurality of electronic components, the electronic components are electrically connected to the at least one conductive line, the at least one conductive line includes a power input portion and two power output portions, the power input portion forms a second electric transmission portion, the second electric transmission portion is separatably electrically connected to the first electric transmission portion, the plasma tube has a light-emitting main body and two electrodes which are disposed on the light-emitting main body, the light-emitting main body at least partly corresponds to the light-penetrable portion, and the two electrodes are respectively electrically connected to the two power output portions.

To achieve the above and other objects, a light-emitting keyboard is further provided, including a keyboard module and a light-emitting module. The keyboard module has a cover, a base, a circuit substrate, a plurality of keycaps and a light-emitting assembly, the cover covers the base, the cover and the base define an interior space, the circuit substrate is for being electrically connected to a first power source and disposed in the interior space, each said keycap is reciprocatably positioned on the cover, the keycaps are for being optionally pressed to actuate a part of the circuit substrate, the light-emitting assembly is received in the interior space and has a substrate and a boost circuit, the boost circuit is disposed on the substrate, the boost circuit includes at least one conductive line and a plurality of electronic components, the electronic components are electrically connected to the at least one conductive line, the at least one conductive line includes a power input portion and two power output portions, the power input portion is for being electrically connected to a second power source, and the two power out portions form a first electric transmission portion. The light-emitting module includes a shell and a plasma tube, the shell has a light-penetrable portion, the plasma tube has a light-emitting main body and two electrodes which are disposed on the light-emitting main body, the light-emitting main body at least partly corresponds to the light-penetrable portion, the two electrodes are electrically connected to a second electric transmission portion, and the second electric transmission portion is separatably electrically connected to the first electric transmission portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of a first preferred embodiment of the present invention;

FIGS. 3 and 4 are cross-sectional side views of the first preferred embodiment of the present invention;

FIG. 5 is a breakdown view of a keyboard module of the first preferred embodiment of the present invention;

FIG. 6 is a diagram showing a relation of a triggering switch of the first preferred embodiment of the present invention;

FIG. 7 is a diagram showing a relation of a light-emitting module of the first preferred embodiment of the present invention;

FIGS. 8 and 9 are stereograms of a second preferred embodiment of the present invention;

FIG. 10 is a stereogram of a third preferred embodiment of the present invention; and

FIG. 11 is a breakdown stereogram of a fourth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

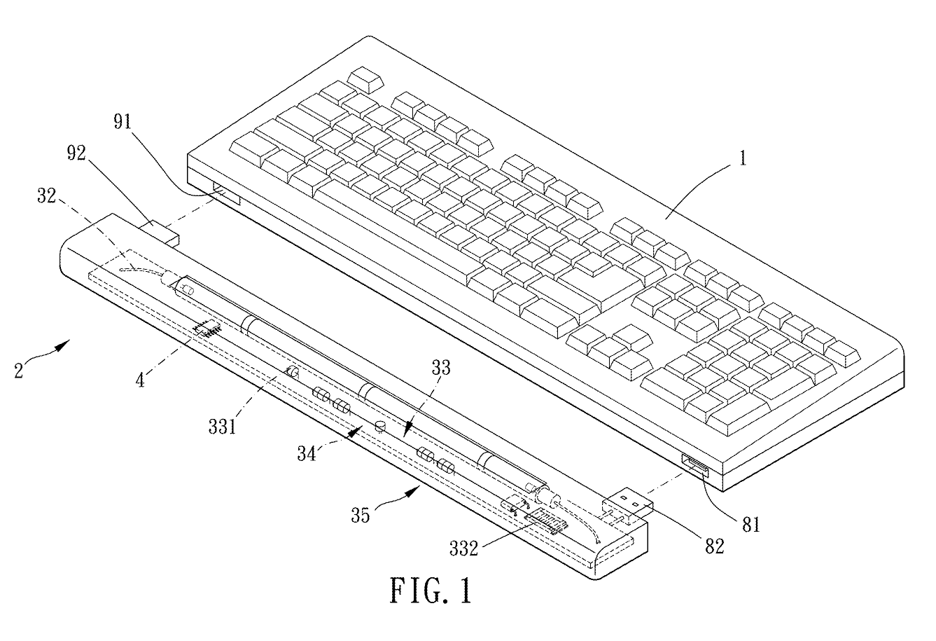

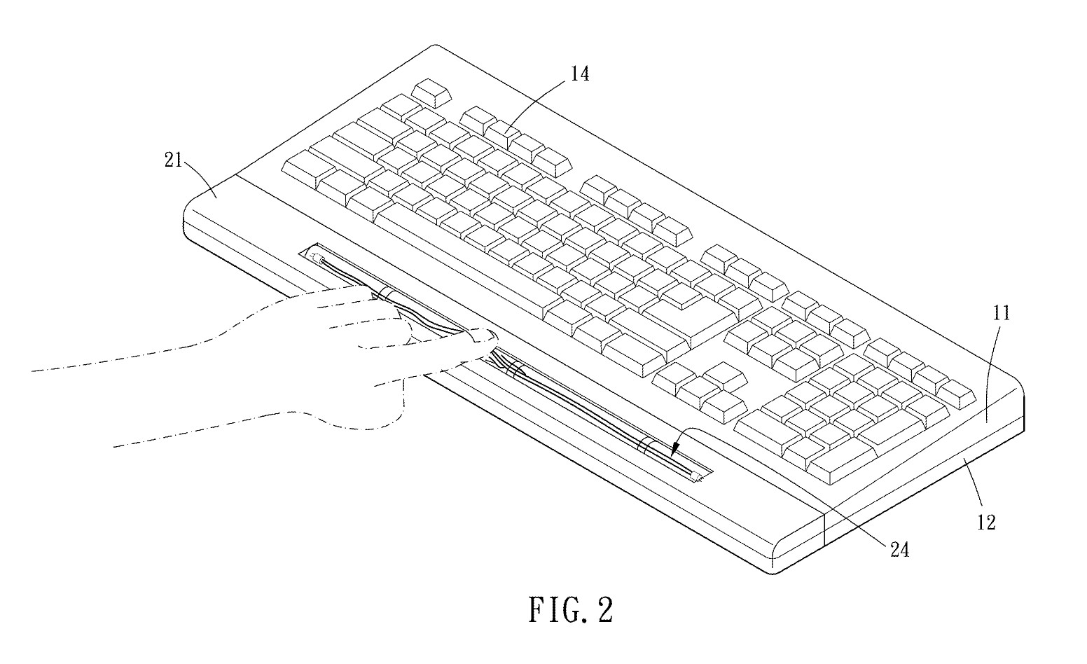

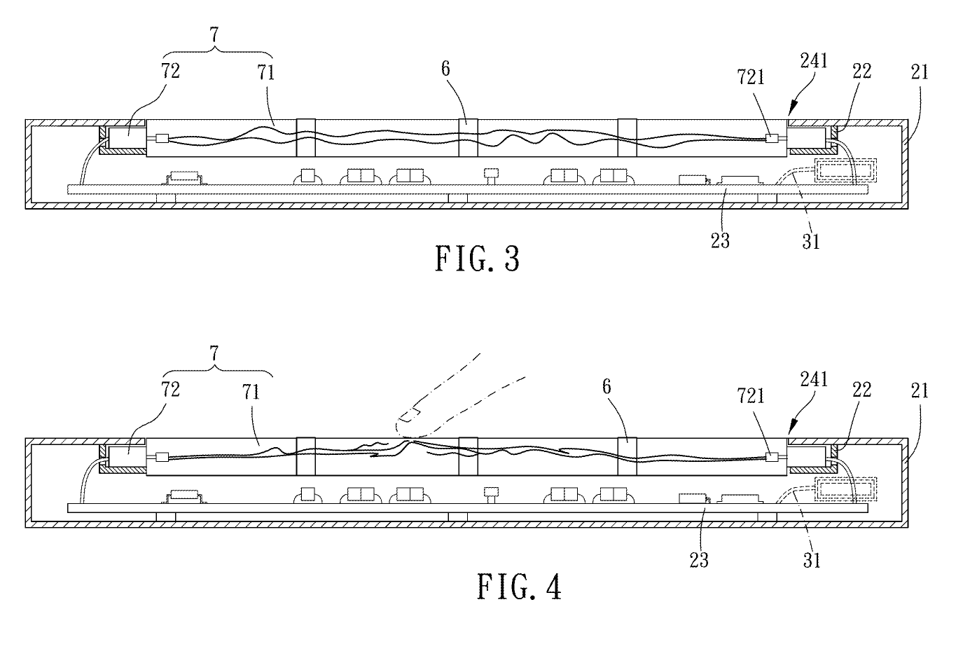

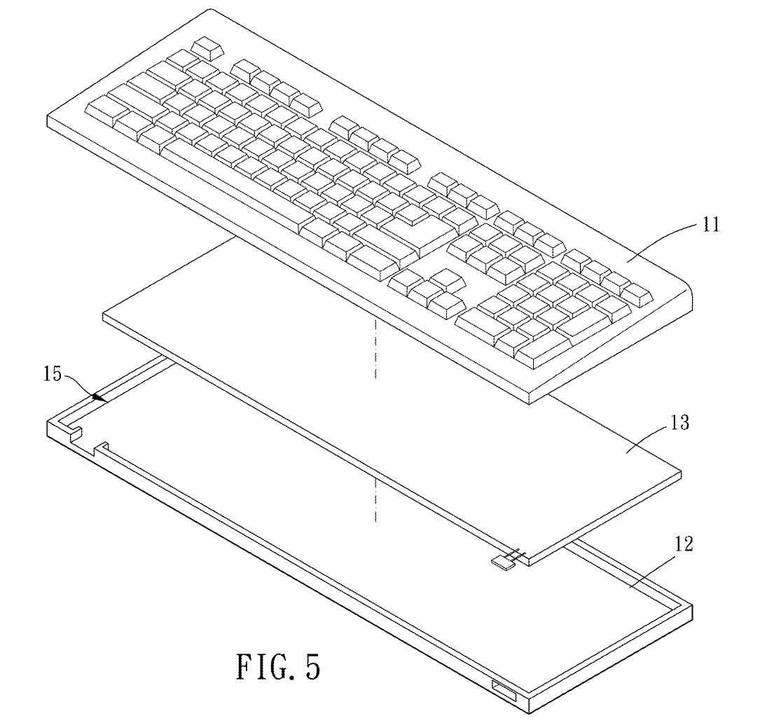

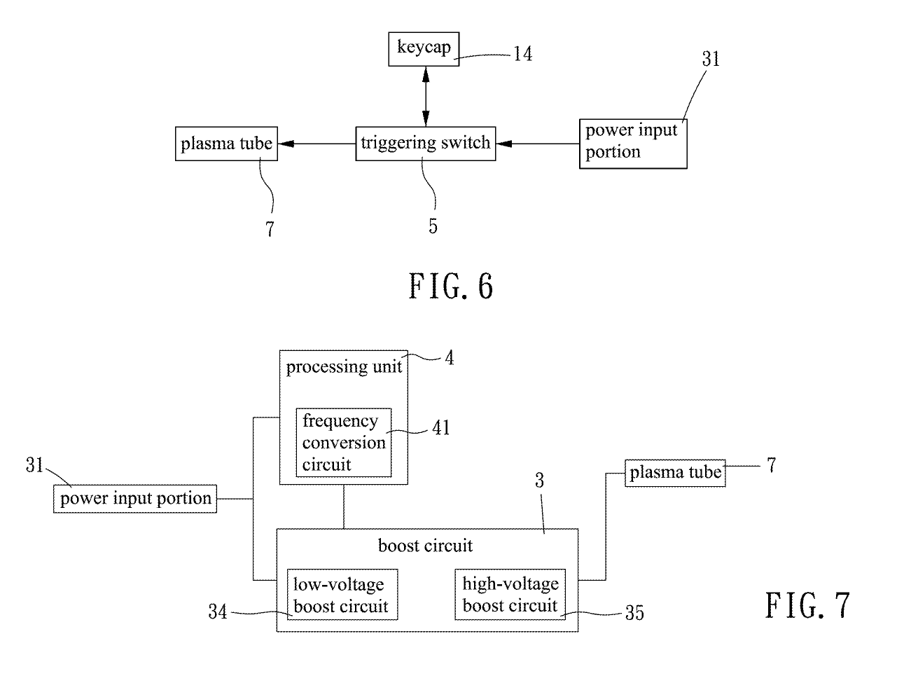

Please refer to FIGS. 1 to 7 for a first embodiment of the present invention. A light-emitting keyboard includes a keyboard module 1 and a light-emitting module 2.

The keyboard module 1 has a cover 11, a base 12, a circuit substrate 13, a first electric transmission portion 81 and a plurality of keycaps 14, the cover 11 covers the base 12, the cover 11 and the base 12 define an interior space 15, the circuit substrate 13 is for being electrically connected to a first power source and disposed in the interior space 15, the first electric transmission portion 81 is for being electrically connected to a second power source, each said keycap 14 is reciprocatably positioned on the cover 11, and the keycaps 14 are for being optionally pressed to actuate a part of the circuit substrate 13.

The light-emitting module 2 includes a shell 21, a substrate 23, a boost circuit 3 and a plasma tube 7, the shell 21 has a light-penetrable portion 24, the boost circuit 3 is disposed on the substrate 23, the boost circuit 3 includes at least one conductive line and a plurality of electronic components 33, the electronic components 33 are electrically connected to the at least one conductive line, the at least one conductive line includes a power input portion 31 and two power output portions 32, the power input portion 31 forms a second electric transmission portion 82, the second electric transmission portion 82 is separatably electrically connected to the first electric transmission portion 81, the plasma tube 7 has a light-emitting main body 71 and two electrodes 72 which are disposed on the light-emitting main body 71, the light-emitting main body 71 at least partly corresponds to the light-penetrable portion 24, and the two electrodes 72 are respectively electrically connected to the two power output portions 32. The two electrodes 72 are disposed on two opposite ends of the light-emitting main body 71, the light-emitting main body 71 and the two electrodes 72 are coaxially arranged, each said electrode 72 includes an electrode cap tube 721 which is located in the light-emitting main body 71 and is hollow, and the two electrode cap tubes 721 are substantially coaxially arranged.

A light emitted from the light-emitting module 2 can directly shine on surfaces of the keycaps 14 so that a user can see each said keycap 14 in the dark without making his/her eyes feel uncomfortable. In addition, the light-emitting module 2 is electrically connected to the keyboard module 1 externally, so it is convenient for the user to take the light-emitting module 2 to any places s/he wants. More importantly, the second electric transmission portion 82 of the light-emitting module 2 is engaged with the first electric transmission portion 81 of the keyboard module 1 externally so that the keyboard module 1 does not need additional light path arrangement, light-guiding, light-penetrating, and light-softening structures; therefore, the keyboard module 1 has a simple structure, and it is cost-saving and quickly to manufacture the keyboard module 1.

In the first embodiment, the first and second electric transmission portions 81, 82 are respectively a USB connector, so the first and second electric transmission portions 81, 82 can be widely used on keyboards having USB interfaces. In addition, a color of the light-emitting module 2 may be changed in accordance with different requirements. When one of the keyboard module 1 and the light-emitting module 2 is damaged, the other of the keyboard module 1 and the light-emitting module 2 can still be used without replacing the whole light-emitting keyboard. It is to be noted that the first and second power sources may be the same power source, for example but not limited thereto, the circuit substrate 13 is electrically connected to the first electric transmission portion 81, and the second electric transmission portion 82 is electrically connected to the first electric transmission portion 81 so that the first power source can provide power through the circuit substrate 13 to the light-emitting module 2. In other embodiments, the first and second power sources may be independent power sources.

Specifically, regarding a circuit structure of the light-emitting module 2, the conductive line is buried in the substrate 23, and the substrate 23 and the conductive lines define a printing circuit board; and of course, the conductive lines may be arranged on the substrate 23 in other ways. The boost circuit 3 transfers a low-voltage direct current which is input by the power input portion 31 to a high-voltage alternating current and supplies the high-voltage alternating current through the two power output portions 32 to the plasma tube 7. The boost circuit 3 may transfer the low-voltage direct current into a light-voltage pulsed direct current.

The light-emitting module 2 further includes a processing unit 4 which is disposed on the substrate 23, the processing unit 4 includes a frequency conversion circuit 41 which is electrically connected to the power input portion 31 and the boost circuit 3, the frequency conversion circuit 41 is used to transfer an input power source which has a first frequency from the power input portion 31 to at least one output power source which has a second frequency and an output power source which has a third frequency, the at least one output power source having the second frequency and the output power source having the third frequency are transmitted to the boost circuit 3 in a preset sequence, the first frequency and the second frequency are different, and the second frequency and the third frequency are different; therefore, the plasma tube 7 produces the light which waves continuously based on the power sources having different frequencies input by the boost circuit 3.

The plurality of electronic components 33 include a plurality of passive components 331 and at least one transformer 332, and the plurality of passive components 331 are electrically connected to one another to form a low-voltage boost circuit 34 which is electrically connected to the power input portion 31 and the processing unit 4 so as to boost the power source provided by the circuit substrate 13, for example, from 1.5˜3.5V to 12˜15V. The at least one transformer 332 forms a high-voltage boost circuit 35 which is electrically connected between the low-voltage boost circuit 34 and the two power output ends so as to transfer a low-voltage power to a high-voltage power, for example, from 12˜15V to 700˜900V, for the plasma tube 7 to use.

In addition, the light-emitting module 2 further has a triggering switch 5, the triggering switch 5 optionally electrically connects the power input portion 31 and the plasma tube 7, and the triggering switch 5 is used to detect movements of the keycaps 14. When one said keycap 14 is pressed to move downward to a predetermined position, the triggering switch 5 electrically connects the power input portion 31 and the plasma tube 7; otherwise, the triggering switch 5 electrically disconnects the power input portion 31 and the plasma tube 7.

It is to be noted that when a finger of a human body touches the light-emitting main body 71, the light in the light-emitting main body 71 undergoes electronic neutralization (when the human body functions as a grounding wire), and a part of the light is guided to a place that the finger touches so as to produce a specific light path. Therefore, in order to retain this characteristic of the plasma tube 7, in the first embodiment, the light-penetrable portion 24 is a through hole 241, the light-emitting main body 71 is exposed from the through hole 241 and non-protrusive beyond the shell 21, and the through hole 241 allows the user to touch the light-emitting main body 71 directly. With the design that the light-emitting main body 71 does not protrude beyond the shell 21, the keycaps 14 are lighted up, and the light-emitting main body 71 can be effectively prevented from being impacted unexpectedly so as to protect a structural integrity of the light-emitting main body 71. It is to be noted that in an opening direction of the through hole 241, and the shell 21 covers the two electrodes 72 completely so as to prevent the user from touching the electrode 72 and experiencing an electric shock and to block objects from attaching on each said electrode 72, for example, in an axial direction the light-emitting main body 71, the shell 21 abuts against the light-emitting main body 71. It is understandable that in other embodiments, the light-penetrable portion is a cover board which is made of a light-penetrable material, or the whole shell may be made of a transparent material.

Preferably, the light-emitting module 2 further includes at least one protecting member 6, and each said protecting member 6 covers at least a part of the light-emitting main body 71 so as to prevent objects from impacting the light-emitting main body 71 and to absorb or disperse the impact to protect the light-emitting main body 71. Each said protecting member 6 is preferably made of a transparent material so as to provide a preferable light-penetrating effect. More preferably, the shell 21 further has a fixing portion 22 which fixes the plasma tube 7 so as to prevent the plasma tube 7 from moving relative to the shell 21 to prevent collision. Even more preferably, the keyboard module 1 further has a first positioning member 91, the first positioning member 91 is provided on at least one of the cover 11 and the base 12, the light-emitting module 2 further has a second positioning member 92 which is provided on the shell 21, and the second positioning member 92 and the first positioning member 91 are positionably engaged with each other so as to reinforce an engagement strength of the light-emitting module 2 and the keyboard module 1 to prevent the light-emitting module 2 and the keyboard module 1 from falling off from each other due to unexpected collision.

In the first embodiment, the light-emitting module 2 is detachably connected to a side of the keyboard module 1 having a space bar externally; therefore, aside from the effects mentioned above, the user can rest his/her wrist the shell 21 to reduce burden on hands during a typing process.

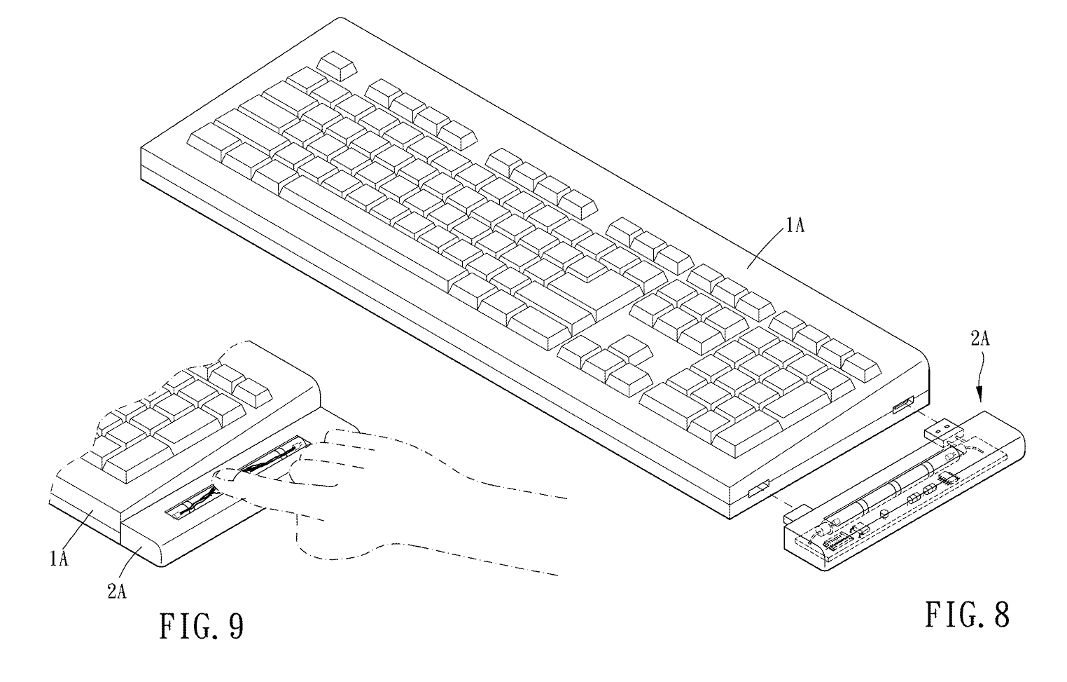

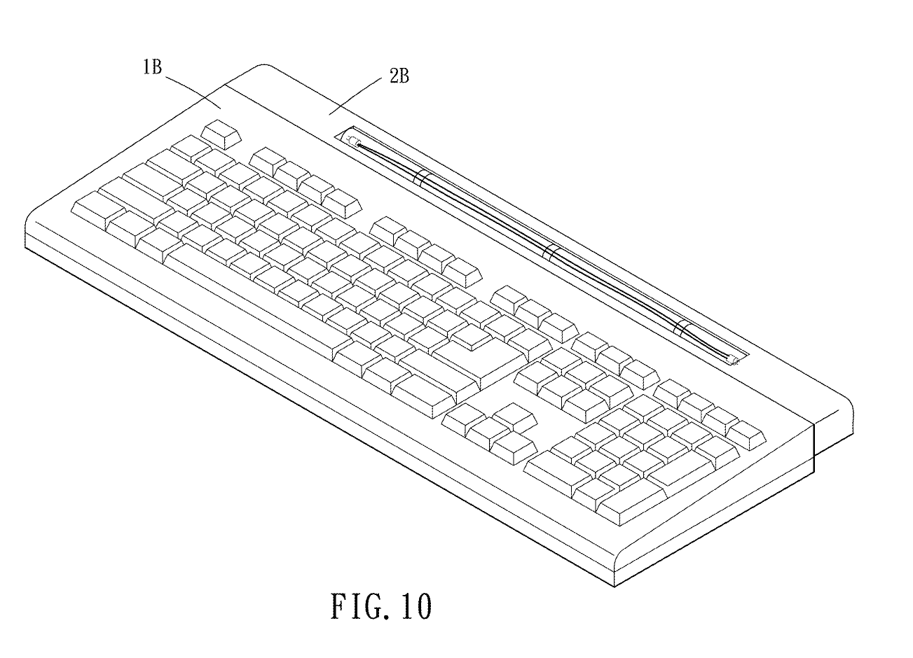

The light-emitting module 2 and the keyboard module 1 may be engaged in other ways. As shown in a second embodiment of FIGS. 8 and 9, a light-emitting module 2A is attached to a side of a keyboard module 1A having a numeric keypad. Or as shown in a third embodiment of FIG. 10, a light-emitting module 2B is attached to a side of a keyboard module 1B having a function keypad.

Back to the first embodiment, it is to be noted that compared with the plasma tube 7, the substrate 23 and the boost circuit 3 are have stronger durability and longer service lives, and the substrate 23 and the boost circuit 3 do not need to be replaced frequently; therefore, the substrate 23 and the boost circuit 3 can be engaged with the keyboard module 1.

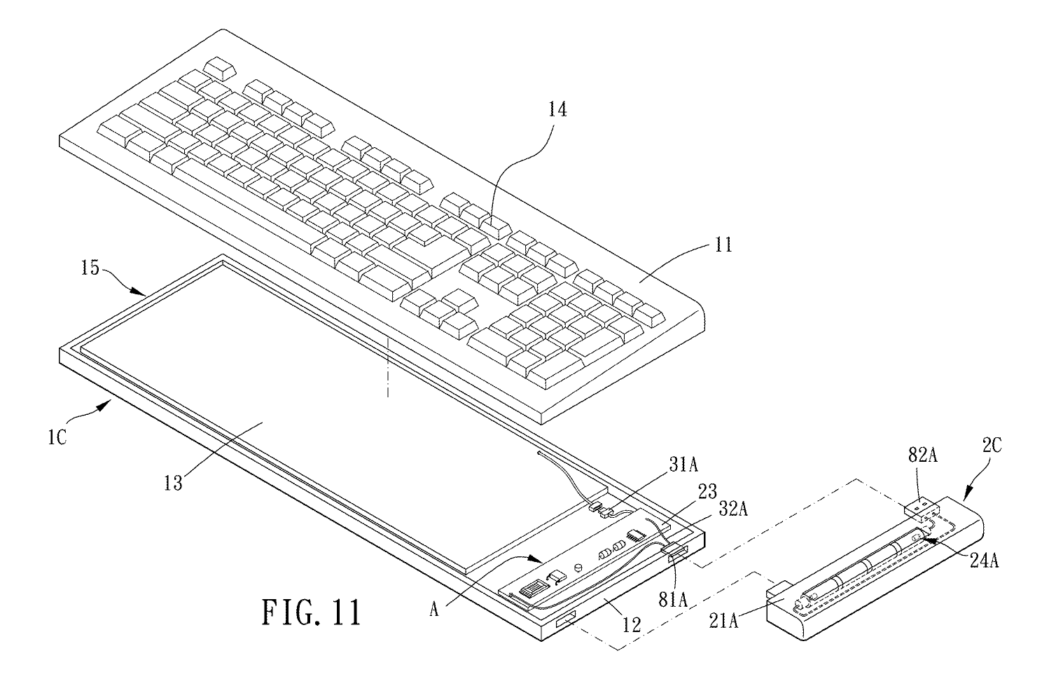

Please refer to FIG. 11 for a fourth embodiment, a light-emitting keyboard is further provided, including a keyboard module 1C and a light-emitting module 2C.

The keyboard module 1C has the cover 11, the base 12, the circuit substrate 13, the plurality of keycaps 14 and a light-emitting assembly A, the cover 11 covers the base 12, the cover 11 and the base 12 define the interior space 15, the circuit substrate 13 is for being electrically connected to a first power source and disposed in the interior space 15, each said keycap 14 is reciprocatably positioned on the cover 11, the keycaps 14 are for being optionally pressed to actuate a part of the circuit substrate 13, the light-emitting assembly A is received in the interior space 15 and has the substrate 23 and the boost circuit 3, the boost circuit 3 is disposed on the substrate 23, the boost circuit 3 includes at least one conductive line and the plurality of electronic components 33, the electronic components 33 are electrically connected to the at least one conductive line, the at least one conductive line includes a power input portion 31A and two power output portions 32A, the power input portion 31A is for being electrically connected to a second power source, and the two power out portions 32A form a first electric transmission portion 81A.

The light-emitting module 2C includes a shell 21A and the plasma tube 7, the shell 21A has a light-penetrable portion 24A, the plasma tube 7 has the light-emitting main body 71 and the two electrodes 72 which are disposed on the light-emitting main body 71, the light-emitting main body 71 at least partly corresponds to the light-penetrable portion 24A, the two electrodes 72 are electrically connected to a second electric transmission portion 82A, and the second electric transmission portion 82A is separatably electrically connected to the first electric transmission portion 81A.

A configuration of the fourth embodiment can decrease a cost of the user purchasing the light-emitting module 2C and increase the willingness of the user purchasing more types of the light-emitting modules 2C so as to increase various lighting modes. It is understandable that, the configurations in the first to fourth embodiments may cooperate with each other.

Given the above, in the light-emitting keyboard, the light-emitting module is separatably electrically connected to the keyboard module so as to simplify the structure of the keyboard module and to decrease a manufacturing difficulty. In addition, when one of the light-emitting module and the keyboard module is damaged, the user only needs to replace the damaged one without replacing the whole light-emitting keyboard.

While we have shown and described various embodiments in accordance with the present invention, it should be clear to those skilled in the art that further embodiments may be made without departing from the scope of the present invention.

What is claimed is:

1. A light-emitting keyboard, including:
a keyboard module, having a cover, a base, a circuit substrate, a first electric transmission portion and a plurality of keycaps, the cover covering the base, the cover and the base defining an interior space, the circuit substrate for being electrically connected to a first power source and disposed in the interior space, the first electric transmission portion for being electrically connected to a second power source, each said keycap being reciprocatably positioned on the cover, the keycaps for being optionally pressed to actuate a part of the circuit substrate;
a light-emitting module, including a shell, a substrate, a boost circuit and a plasma tube, the shell having a light-penetrable portion, the boost circuit disposed on the substrate, the boost circuit including at least one conductive line and a plurality of electronic components, the electronic components being electrically connected to the at least one conductive line, the at least one conductive line including a power input portion and two power output portions, the power input portion forming a second electric transmission portion, the second electric transmission portion being separatably electrically connected to the first electric transmission portion, the plasma tube having a light-emitting main body and two electrodes which are disposed on the light-emitting main body, the light-emitting main body at least partly corresponding to the light-penetrable portion, the two electrodes being respectively electrically connected to the two power output portions.

2. The light-emitting keyboard of claim 1, wherein the light-emitting module further includes a processing unit which is disposed on the substrate, the processing unit includes a frequency conversion circuit which is electrically connected to the power input portion and the boost circuit, the frequency conversion circuit is used to transfer an input power source which has a first frequency from the power input portion to at least one output power source which has a second frequency and an output power source which has a third frequency, the at least one output power source having the second frequency and the output power source having the third frequency are transmitted to the boost circuit in a preset sequence, the first frequency and the second frequency are different, and the second frequency and the third frequency are different.

3. The light-emitting keyboard of claim 1, wherein the light-penetrable portion is a through hole, the light-emitting main body is exposed from the through hole and non-protrusive beyond the shell, and in an opening direction of the through hole, the shell covers the two electrodes completely.

4. The light-emitting keyboard of claim 1, wherein the light-emitting module further includes at least one protecting member, and each said protecting member covers at least a part of the light-emitting main body.

5. The light-emitting keyboard of claim 4, wherein the keyboard module further has a first positioning member, the first positioning member is provided on at least one of the cover and the base, the light-emitting module further has a second positioning member which is provided on the shell, and the second positioning member and the first positioning member are positionably engaged with each other; the shell further has a fixing portion which fixes the plasma tube; the light-emitting module further includes a processing unit which is disposed on the substrate, the processing unit includes a frequency conversion circuit which is electrically connected to the power input portion and the boost circuit, the frequency conversion circuit is used to transfer an input power source which has a first frequency from the power input portion to at least one output power source which has a second frequency and an output power source which has a third frequency, the at least one output power source having the second frequency and the output power source having the third frequency are transmitted to the boost circuit in a preset sequence, the first frequency and the second frequency are different, and the second frequency and the third frequency are different; the light-penetrable portion is a through hole, the light-emitting main body is exposed from the through hole and non-protrusive beyond the shell, and in an opening direction of the through hole, the shell covers the two electrodes completely; in an axial direction of the light-emitting main body, the shell abuts against the light-emitting main body; the plurality of electronic components include a plurality of passive components and at least one transformer, the plurality of passive components are electrically connected to one another to form a low-voltage boost circuit which is electrically connected to the power input portion and the processing unit, the at least one transformer forms a high-voltage boost circuit which is electrically connected between the low-voltage boost circuit and the two power output ends; the light-emitting module further has a triggering switch, the triggering switch optionally electrically connects the power input portion and the plasma tube, the triggering switch is used to detect movements of the keycaps; wherein when one said keycap is pressed to move downward to a predetermined position, the triggering switch electrically connects the power input portion and the plasma tube; otherwise, the triggering switch electrically disconnects the power input portion and the plasma tube; the two electrodes are disposed on two opposite ends of the light-emitting main body, and the light-emitting main body and the two electrodes are coaxially arranged; each said electrode includes an electrode cap tube which is located in the light-emitting main body and is hollow, and the two electrode cap tubes are substantially coaxially arranged; the light-emitting module is detachably connected to a side of the keyboard module having a space bar externally; the first and second electric transmission portions are respectively a USB connector.

6. A light-emitting keyboard, including:
a keyboard module, having a cover, a base, a circuit substrate, a plurality of keycaps and a light-emitting assembly, the cover covering the base, the cover and the base defining an interior space, the circuit substrate for being electrically connected to a first power source and disposed in the interior space, each said keycap being reciprocatably positioned on the cover, the keycaps for being optionally pressed to actuate a part of the circuit substrate, the light-emitting assembly being received in the interior space and having a substrate and a boost circuit, the boost circuit disposed on the substrate, the boost circuit including at least one conductive line and a plurality of electronic components, the electronic components being electrically connected to the at least one conductive line, the at least one conductive line including a power input portion and two power output portions, the power input portion for being electrically connected to a second power source, the two power out portions forming a first electric transmission portion;
a light-emitting module, including a shell and a plasma tube, the shell having a light-penetrable portion, the plasma tube having a light-emitting main body and two electrodes which are disposed on the light-emitting main body, the light-emitting main body at least partly corresponding to the light-penetrable portion, the two electrodes being electrically connected to a second electric transmission portion, the second electric transmission portion being separatably electrically connected to the first electric transmission portion.

7. The light-emitting keyboard of claim 6, wherein the light-emitting assembly further includes a processing unit which is disposed on the substrate, the processing unit includes a frequency conversion circuit which is electrically connected to the power input portion and the boost circuit, the frequency conversion circuit is used to transfer an input power source which has a first frequency from the power input portion to at least one output power source which has a second frequency and an output power source which has a third frequency, the at least one output power source having the second frequency and the output power source having the third frequency are transmitted to the boost circuit in a preset sequence, the first frequency and the second frequency are different, and the second frequency and the third frequency are different.

8. The light-emitting keyboard of claim 6, wherein the light-penetrable portion is a through hole, the light-emitting main body is exposed from the through hole and non-protrusive beyond the shell, and in an opening direction of the through hole, the shell covers the two electrodes completely.

9. The light-emitting keyboard of claim 6, wherein the light-emitting module further includes at least one protecting member, and each said protecting member covers at least a part of the light-emitting main body.

10. The light-emitting keyboard of claim 9, wherein the keyboard module further has a first positioning member, the first positioning member is provided on at least one of the cover and the base, the light-emitting module further has a second positioning member which is provided on the shell, and the second positioning member and the first positioning member are positionably engaged with each other; the shell further has a fixing portion which fixes the plasma tube; the light-emitting assembly further includes a processing unit which is disposed on the substrate, the processing unit includes a frequency conversion circuit which is electrically connected to the power input portion and the boost circuit, the frequency conversion circuit is used to transfer an input power source which has a first frequency from the power input portion to at least one output power source which has a second frequency and an output power source which has a third frequency, the at least one output power source having the second frequency and the output power source having the third frequency are transmitted to the boost circuit in a preset sequence, the first frequency and the second frequency are different, and the second frequency and the third frequency are different; the light-penetrable portion is a through hole, the light-emitting main body is exposed from the through hole and non-protrusive beyond the shell, and in an opening direction of the through hole, the shell covers the two electrodes completely; in an axial direction of the light-emitting main body, the shell abuts against the light-emitting main body; the plurality of electronic components include a plurality of passive components and at least one transformer, the plurality of passive components are electrically connected to one another to form a low-voltage boost circuit which is electrically connected to the power input portion and the processing unit, the at least one transformer forms a high-voltage boost circuit which is electrically connected between the low-voltage boost circuit and the two power output ends; the light-emitting assembly further has a triggering switch, the triggering switch optionally electrically connects the power input portion and the plasma tube, the triggering switch is used to detect movements of the keycaps; wherein when one said keycap is pressed to move downward to a predetermined position, the triggering switch electrically connects the power input portion and the plasma tube; otherwise, the triggering switch electrically disconnects the power input portion and the plasma tube; the two electrodes are disposed on two opposite ends of the light-emitting main body, and the light-emitting main body and the two electrodes are coaxially arranged; each said electrode includes an electrode cap tube which is located in the light-emitting main body and is hollow, and the two electrode cap tubes are substantially coaxially arranged; the first and second electric transmission portions are respectively a USB connector.
